(19) United States
(12) Patent Application Publication
(10) Pub. No.: US 2005/0108066 A1
(43) Pub. Date: May 19, 2005

(54) Property/casualty insurance and techniques

(75) Inventors: James Weidner, Los Angeles, CA (US); David Preimesberg, Los Angeles, CA (US); A. Peter Kezirian JR., Los Angeles, CA (US)

Correspondence Address: McDermott Will & Emery LLP, 600 13th Street, N.W., Washington, DC, 20005-3096, US

(73) Assignee: COOPERATION OF AMERICAN PHYSICIANS, Los Angeles, CA (US)

(21) Appl. No.: 10/958,654

(22) Filed: Oct. 6, 2004

Related U.S. Application Data
(63) Continuation of application No. 10/140,434, filed on May 8, 2002, now abandoned.
(60) Provisional application No. 60/289,127, filed on May 8, 2001.

(30) Foreign Application Priority Data
May 8, 2002 (WO) PCT/US02/14293

(51) Int. Cl. G06F 17/60

(52) U.S. Cl. 705/4

(57) ABSTRACT

An insurance entity, organized as a stock, mutual or reciprocal company, offers claims paid property and causality insurance. This organization offers improvements over a risk-sharing vehicle such as MPT by removing unlimited liability and by capping annual assessments, while retaining the lower cost achievable by a claims-paid policy.

### RELATED APPLICATIONS

This application is a continuation of U.S. patent application Ser. No. 10/140,434, filed on May 8, 2002, entitled “Property/Casualty Insurance and Techniques,” which claims the benefit under 35 U.S.C. §119(e) of U.S. Provisional Patent Application No. 60/289,127 filed on May 8, 2001, entitled “Professional Liability Insurance Techniques,” both of which are incorporated by reference herein in their entireties.

### TECHNICAL FIELD

The invention is related to insurance and more particularly to property and casualty insurance and techniques.

### BACKGROUND

In the usual insurance transaction, a party wishing to protect himself against a risk makes a contract with an insurance company, typically exchanging payments (premiums) for a promise (set forth in an insurance policy) to have the risk covered. There are a number of organizational forms used for insurance companies, depending on the state of formation, including stock insurers, mutual insurers and reciprocal insurers (also called interinsurance exchanges). Typically, the insured had no special relationship to the insurer. There are also forms of “captive” insurance companies, where the insurer is owned by the insureds.

Insurance companies predict losses of existing and potential policyholders and set premiums based on actuarial analysis. This process of matching the premium to the risk is called “underwriting.” The determination of whether to accept a potential policyholder is based on policyholder characteristics obtained by application, questionnaire, credit check and other factual inquiries. Premiums may be uniform for all policyholder that purchase the same coverage, or the insurance company may use a classification plan. A classification plan uses known characteristics of a policyholder to determine the likelihood that the policyholder will submit claims to the insurance company, thereby incurring losses. A classification plan is also used to determine the expected size of claims based on known characteristics of the policyholder. In the case of physician professional liability insurance, physicians may be classified by specialty, and uniform rates charged for physicians within each specialty class.

Even taking into account adjustments based on specialty classification and other premium adjustments, policyholders with a history of few claims may be able to establish that, by sharing risk among a smaller, more select group of policyholders, overall losses (and therefore premiums) may be reduced. Captive insurers are often formed by organizations or individuals that are in a common business, who believe that, because they represent better than average risks, they will be able to provide coverage to themselves at better, more stable rates than commercial insurers.

Captive insurance companies typically write policies and reserve for losses in a manner similar to commercial insurance companies. For example, a professional liability insurance company (captive or commercial) generally will issue either (i) a “claims made” policy, meaning that a policyholder's policy for a given policy year covers a claim (up to the policy limits) based on whether the claim is filed or reported during the policy period (in other words, filing the claim triggers coverage under the policy), or (ii) an “occurrence” policy, meaning that the policy covers all such claims that arise out of occurrences during the policy year, even if the claim if filed thereafter. The insurance company generally is obligated to defend the claim and eventually pay any losses, and the losses and costs will apply to the policy year that the claim was made. In advance of payment of the claim, the insurance company will set a “reserve” for the claim on its books. An insurance company's reserves constitute a liability. State insurance laws govern the surplus of assets over liabilities that must be maintained by an insurance company in order to be licensed in or do business in the state.

### SUMMARY OF THE INVENTION

The invention is directed to providing property and casualty insurance in a form which improves over both the usual forms (i.e., “claims made” and “occurrence” coverage) of insurance company product and coverage provided by captive programs, including an interindemnity trust. This advancement is created by providing a claims paid insurance product under applicable insurance laws, as opposed to claim made or occurrence coverages.

Claims-paid coverage may be obtained currently in the medical malpractice environment in a few jurisdictions under restricted conditions. However, the success in this line of risk sharing can be translated into advancements for the property and casualty insurance businesses that require risk management, sophisticated claims handling and either long-tail or short-tail liabilities. For example, dental malpractice, legal malpractice, earthquake damages and general property risks all have characteristics that can benefit from this new and improved form of insurance. In general, a claims-paid insurance policy is an effort to align the incentives of the covered entity, the risk-taker and the injured person in a formula that benefits all parties. A claims-paid policy encourages appropriate risk management, underwriting and claims handling in a manner that is different than the current insurance policies available in the marketplace.

In one embodiment, the claims paid insurance policy can be provided by a “risk retention group” (“RRG”). The definition of “risk retention group” under the Federal Liability Risk Retention Act of 1986 provides that an RRG means any “corporation or other limited liability association” that, among other requirements, “is chartered and licensed as a liability insurance company under the laws of a State and authorized to engage in the business of insurance under the laws of such State.” (15 U.S.C. 3901(a)(4)) The following is a summary of RRG requirements in addition to being licensed as an insurer in a state: (1) the RRG's primary activity and primary purpose consists of spreading the liability exposures of its members; (2) the RRG does not exclude persons from membership solely in order to provide a competitive advantage for RRG members; (3) all owners are insureds; (4) the members/insureds are engaged in activities that are similar with respect to the risks raised; (5) the only insurance or reinsurance provided relates to the liability risks of RRG members; and (6) the name includes the phrase “risk retention group.”

Since an RRG is, by definition, a captive or select insurer, RRGs often are formed under state insurance laws that apply to captives. Those states that have broad captive insurance company laws generally allow a captive insurer to be organized as a stock, mutual or reciprocal insurer. A reciprocal insurer (which is similar to the current organizational form of the Mutual Protection Trust (“MPT”), which is described below) is an unincorporated form of insurance company, where the insureds (also called “subscribers”) exchange contracts of insurance with each other through an attorney in fact. The attorney in fact may obligate the subscribers severally (not jointly) on contracts of insurance made by the subscribers, within the limits specified in each subscriber's power of attorney to the attorney in fact.

However, claims-paid coverage can also be provided through the traditional vehicles if a company chooses to obtain the regulatory approvals from appropriate state insurance commissioners for this new type insurance. The RRG and captive vehicles are highlighted simply because these structures are most akin to the current MPT format and facilitate descriptions of the coverage. Claims-paid coverage is not dependent on the corporate structure or licensed entity. Rather it is a new product that provides a unique form of risk shifting arrangement that prompts enhanced cooperation between the insured and insurer.

The foregoing and other features, aspects and advantages of the present invention will become more apparent from the following detailed description of the present invention when taken in conjunction with the accompanying drawings.

### BRIEF DESCRIPTION OF THE DRAWINGS

The other features, aspects and advantages of the system of the present invention will be apparent from the following description in which:

FIG. 1 is a diagram illustration the relationship between an insurer and an insured as known in the prior art.

FIG. 2 is a diagram illustration relationships between insureds and an interindemnity trust entity such as MPT (described below).

FIG. 3 is a diagram illustrating the relationship between an insured and an insurer providing “claims paid” coverage (described below) in accordance with one aspect of the invention.

FIG. 4 is a flow chart of a process for forming a “claims paid” property and casualty liability insurance company in accordance with another aspect of the invention.

### DETAILED DESCRIPTION OF THE EMBODIMENTS

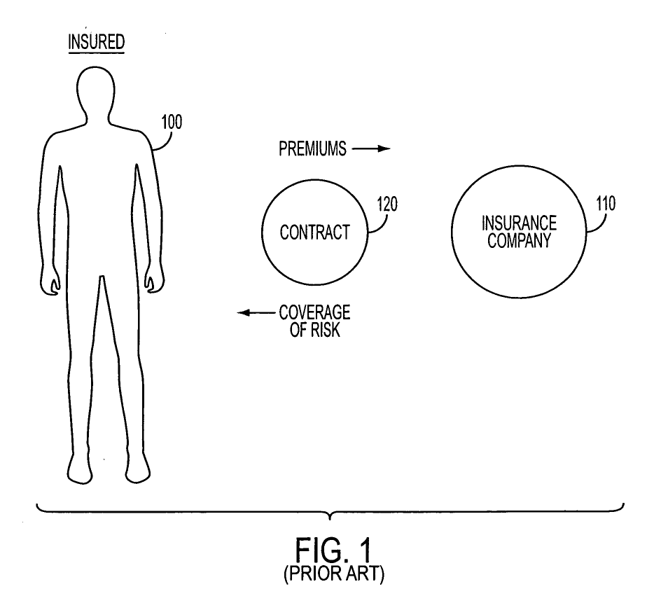

FIG. 1 is a diagram illustrating the relationship between an insurer and an insured as known in the prior art. In FIG. 1, an insured (100) enters into a contract (120) with an insurance company (110) pursuant to which the insured agrees to pay premiums to the insurance company in exchange for an insurance company assuming all or part of economic loss which results from a risk occurring. Examples of a risk that might cause economic loss against which an insured might desire insurance include:
(1) homeowner's liability;
(2) professional negligence liability for physicians, dentists or other professionals; or
(3) automobile liability.

Insurance companies are highly regulated entities. These entities are required to set aside appropriate reserves to pay for the eventuality that a loss might occur. The reserves generally must take into account both reported (but not yet paid) losses, and incurred but not reported (“IBNR”)losses.

Currently, insurance companies offer one of two types of policies: occurrence or claims made. Under and occurrence policy, an insurance company assumes the risk for certain events that “occur” during a particular period of time. The insured party has an open ended period of time after discovery of the injury to report the claim to the carrier. Under occurrence policies, injuries identified in a current year can reach back many years to trigger the policy covering the time that the injury first started for insurance coverage. Due to the uncertainty of future liability, occurrence policies are significantly more expensive than the only other alternative in the market, claims-made. Claims-made coverage focuses upon the date of discovery of the loss rather the date the event occurred. Claims-made policies grew in popularity in the 1960s and 1970s because these policies provide a greater degree of certainty to the carriers as to potential exposures and are less expensive for the insured. These two policies are offered by most carriers, with claims-made the more common form of coverage.

In addition to traditional insurance, new types of risk sharing techniques have been developed including the “claims paid” coverage. The risk alternative is operated through statutory schemes in various states and is limited to the physician liability risks. Under these regulatory regimes, a company must establish an interindemnity trust or risk pool, subject to the specific statutory requirements for such programs, as opposed to the general insurance laws of the state. Only a few states, notably California, permit such arrangements. Currently, claims paid medical malpractice coverage may be provided to California physicians and surgeons (collectively, “physicians”) who are members of a cooperative corporation (established under the California Corporations Code), through an unincorporated interindemnity or reciprocal or interinsurance arrangement established under Section 1280.7 of the California Insurance Code. Such contractual arrangements “do not collect in advance of loss any moneys other than contributions by each member to a collective reserve trust fund or for necessary expenses of administration.” Members/insureds agree to make initial contributions to the corpus of the trust and to pay annual premiums in exchange for defense of claims and for an agreement to pay any claims for which the member might become liable. Members are subject to multiple assessments, to the extent that income earned on the corpus of the reserve fund in insufficient to pay claims, costs judgments, settlements and administration costs. Currently there is only one such operating entity established under California law: the Mutual Protection Trust (“MPT”) provides claims paid coverage to those physicians who are members of Cooperative of American Physicians, Inc. (“CAP”). (The operations of CAP and MPT, as well as the claims paid concept, are further described hereinafter.)

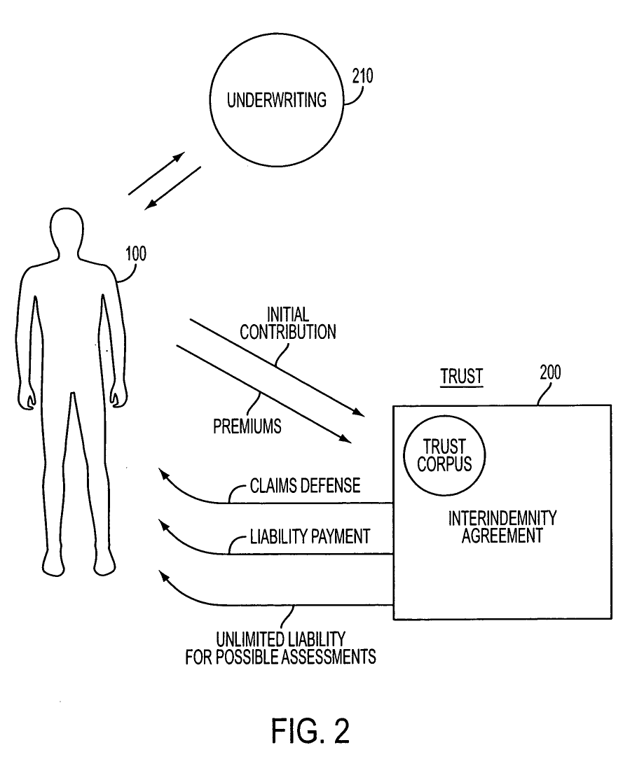

FIG. 2 is a diagram illustrating relationships between the covered persons or members (100) and a claims paid program such as MPT (200). In a claims paid program, liability accrues only when the claim is paid, not when the claim is made. If coverage for an insured terminates, any claim against the insured and all potential losses (including liability relating to claims already filed) stay with the insured. This arrangement is a markedly different result than a traditional “claims made” insurance program, where all claims that have been reported when coverage ends are the responsibility of the insurer, and the insured is only responsible for (or must purchase “tail” coverage for) unreported claims. Termination from a claims paid program without tail coverage is highly detrimental to the insured, and therefore an entity such as MPT is not permitted to terminate a physician from the program or nonrenew coverage, except under limited circumstances. For this reason, before a person is admitted as a member of MPT, a rigorous under writing process (210) is undertaken. This care insures that only individuals who are committed to practicing relatively safer medicine compared with the population of professional at large, i.e., individuals who are sound risks, are admitted into the group. The insured (100), makes an initial contribution and pays “assessments” in exchange for claims defense and for payment of any liability, up to specified limits, resulting from the claim.

An interindemnity trust such as MPT, or any other entity permitted under Section 1280.7 of the California Insurance Code or similar provisions in other states, has certain disadvantages. These drawbacks include the potential for unlimited liability for the individual members of the trust, possible mid-year assessments when payments of claims by the trust exceed premiums paid in for any particular fiscal year, limitation to California physicians, and the fact that the arrangement is not insurance under state law, and therefore may not be as acceptable to potential participating physicians.

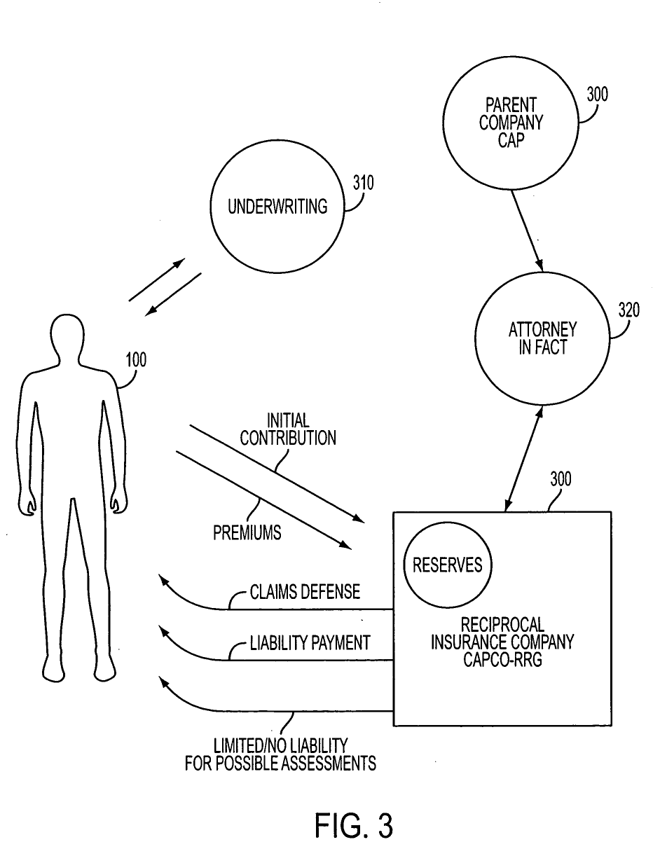

FIG. 3 is a diagram illustrating the relationship between an insured and an insurer providing claims paid coverage in accordance with one aspect of the invention. One purpose of FIG. 3 is to demonstrate the uniqueness of the claims-paid policy and that such a policy can be used in a variety of particular and general insurance settings. As shown in FIG. 3, an insured (100) makes an initial contribution to the company (300), which forms a pool of money to be used as “surplus,” to be used to pay claims after other funds have been exhausted. These funds can be held as subscriber account and returnable to the insured under certain conditions to the contribution can be deemed permanent and used by the company for purposes deemed appropriate. In addition, the insured (100) pays annual premiums in exchange for a claims paid insurance policy, which provides defense fan indemnity coverage. As in the case of MPT, each insured undergoes a vigorous underwriting process before the policy is issued.

In an advantageous implementation of the invention, the insurance company (300) is a reciprocal insurance company licensed as an RRG under the Federal Liability Risk Retention Act of 1986 and corresponding state implementing legislation, for example, the implementing legislation in the State of Hawaii.

This improved form of organization provides a number of benefits over MPT. For example, this form of organization allows for the potential elimination of the unlimited liability of the members/insureds for assessments. Instead, assessments are limited to the extent provided in the reciprocal's contracts with the insured. Generally, assessments are limited to a multiple of premium, and may be completely eliminated or limited to a fraction (e.g., 50%) of premium. In addition, the company would be required to build reserves for the cost of defending a known claim, which would provide a greater degree of security to the insured. Further, the protection provided is actual insurance and would be more acceptable to insureds and those entities covered by insurance such as hospitals than a trust arrangement with unlimited liability that is established under special California enabling legislation.

In one form of the invention, CAP, as the parent company (300) would create an organization to function as an attorney-in-fact (320) (called for convenience “CAP Attorney”). The attorney-in-fact would act on behalf of the members of the reciprocal insurance company (300). The reciprocal entity, called for convenience the CAP Insurance Exchange (“CAP Exchange”), would be created for the purposes of providing “claims paid” medical malpractice insurance of other professional liability insurance and other casualty insurance products brokered by CAP. CAP Attorney would be a wholly owned subsidiary of CAP and would provide the necessary services for the operation of CAP Exchange. Before discussing any potential operations of the CAP Exchange, it is proper to address in detail the operation of MPT and CAP.

CAP is a California cooperative corporation formed under Section 25100(q) of the California Corporations Code to provide a means by which physicians can join together to mutually protect their professional standing and finances against claims of professional negligence and to continue their practice of medicine in a manner which can be economically and socially justified. As a consumer cooperative, CAP may engage in any legal business as long as its business is primarily for the mutual benefit of its members as patrons of the cooperative. Membership in CAP is limited to physicians.

Medical malpractice coverage is provided to CAP members through MPT. MPT is organized pursuant to the provisions of Section 1280.7 of the California Insurance Code. MPT is an unincorporated interindemnity trust arrangement created for the purpose of offering professional negligence liability protection to eligible physicians who reside and are licensed to practice medicine in the State of California. Under this structure, each MPT member is required to make an initial contribution to MPT trust corpus (individually, the “Initial Trust Contribution” or “ITC” and collectively, the “Corpus”) for coverage with limits of $1.0 million per occurrence with a $3.0 million annual aggregate. (Higher contributions are required if the member requests a greater level of coverage.) The ITC currently equals what a physician would pay in assessments for his first year of mature MPT coverage and is refunded upon the retirement or voluntarily termination of a member from MPT if the physician is in good standing and subject to the bylaws of MPT.

A member is also required to pay annual dues to CAP and is personally liable for assessments when the dues and earnings of the MPT fund are not sufficient to cover the operational costs for CAP and MPT. As this time, each member pays an assessment based upon an allocation formula. This formula takes into consideration the risk classification of the physician's specialty, limits of liability, the number of months of retroactive coverage, and other related costs of operation and risk coverage related to MPT. The assessment is determined by MPT and does not require rate filings or approvals from the California Department of Corporations, which is the current state regulator of CAP and MPT.

The coverage provided through CAP and MPT is for claims defense and claims payment protection as compared to “claims made” insurance that is the common medical malpractice insurance policy provided in California and elsewhere in the United States. While these policies provide similar protection to doctors, MPT's program differs from claims made insurance coverage in the method by which present and future claims and administrative costs are funded and in the continuing unlimited financial obligation of its members to MPT.

Under the MPT claims-paid coverage, a claim remains the liability of the member (collectively, the “Members' Liabilities”) until the liability for the claim is settled and paid. A claim becomes an obligation of MPT once it is determined to be an obligation under the interindemnity contract (i.e., when there is an obligation to pay the claim). With a traditional insurance policy, the claim is the liability of the insurance company upon the determination that the insured has coverage for the particular claim. Under a claims-made regime, an insurance company must post a reserve for indemnity and defense costs as soon as a claim is reported. However, in a claims-paid insurance world, an insurance company needs to post a reserve only for the defense costs and collect the indemnity expense, through premiums, in the year that the indemnity will be paid, if ever.

Each year's assessment process estimates the resources needed to pay claims and operating expenses for the following year. CAP had the statutory authority to seek mid-term assessments in the event MPT's resources are insufficient to meet current obligations. The accounting treatment of MPT's liabilities follows the “claims paid” nature of the coverage, and explicitly differentiates between liabilities of MPT and the Member's Liabilities.

Although membership in CAP is available to any physician licensed to practice medicine, admission to MPT is not automatic. Each prospective physician participant must undergo a rigorous application and underwriting process, which culminates with a decision by the Quality Control Board (“QCB”) to admit or reject the prospective member. The QCB is composed of six member physicians who are responsible for reviewing the application and record of each nominated physician MPT's processes help insure that only the highest quality physicians are admitted to CAP and MPT. As a membership organization, CAP may employ more restrictive selection criteria than other industry participants. Experience has shown that approximately 84% of all applications for membership to CAP and MPT would be accepted by QCB, which compares to the 95% acceptance rate of other California malpractice insurers.

The CAP Exchange and CAP Attorney discussed initially in conjunction with FIG. 3a would implement significant state-of-the-art improvements to the current CAP-MPT claims paid product, as discussed above. First and foremost, unlike CAP-MPT, the CAP Exchange insureds would no longer have unlimited liability for assessments to meet insured losses; instead, for the first time, annual assessments would be capped. Second, also unlike CAP-MPT, the CAP Exchange claims-paid policy would be deemed to be insurance, regulated by state insurance departments, and legally and commercially respected as such, throughout the United States and in the reinsurance marketplace. Third, as insurance, rather than in an interindemnity insurance trust, the CAP Exchange claims paid policy may be acceptable to more physicians, and could be offered outside of California. Fourth, as claims-paid insurance, the policy would be able to combine the best elements of the statutory scheme and insurance law to enhance the security to the covered entities, such as posting reserves for defense costs which is not a permitted activity for CAP-MPT. These advantages, combined with CAP Exchange's lower cost and better loss results than its competitors' policies, would help CAP Exchange spread the professional liability risk through increased growth. Fifth, as in the case of CAP-MPT, the claims-paid format would encourage CAP Attorney, CAP Exchange and the insured to seek ways to reduce risk. Better risk management reaps immediate gains to all parties through lower assessment costs and needs by all parties.

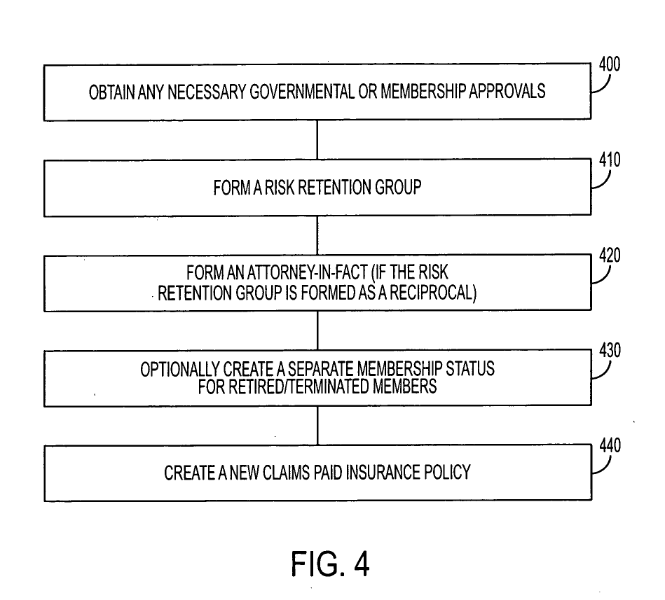

FIG. 4 is a flow chart of a process for creating a claims paid professional liability insurance company. An investor group creates a corporate entity and seeks government approvals, particularly the licensure to engage in the business of insurance (400). As a part of this business plan, the investors must decide whether to create a mutual, stock or reciprocal company and evaluate which of these structures favors the objectives of the nascent company (410). If the program is a liability insurance program to be owned by its insureds, the investors may choose to seek RRG status (520), but this element is not essential to the creation of a claims-paid insurance company. Optionally, the organizers may create a separate membership status for retired/terminated members (530). The organizers also must retain management and create a claim-paid policy acceptable for an individual jurisdiction (440).

Although the present invention has been described and illustrated in detail, it is clearly understood that the same is by way of illustration and example only and is not to be taken by way of limitation, the spirit and scope of the present invention being limited only by the terms of the appended claims.

1. A method for insuring a property or casualty loss of a party with a claims paid insurance policy, the method comprising:
determining a claims paid insurance premium for the insured party;
charging the premium to the insured party;
obligating the insured party to pay the premium without an opportunity to cancel the policy;
receiving payment of the premium from the insured party; and
assuming liability for a claim against the insured party responsive to the claim being resolved.

2. The method of claim 1, wherein determining a claims paid insurance premium further comprises:
evaluating a cost object model to forecast expenditures bases on claims asserted against a group of insured parties;
calculating an overall premium for the group of insured parties from the forecasted expenditures; and
allocating a portion of the overall premium to the insured party.

3. The method of claim 2, wherein allocating a portion of the overall premium further comprises:
applying, to the allocated portion, an adjustment factor based at least upon risk relativity, risk maturity, geographic, or policy-specific risk experience.

4. The method of claim 1, further comprising:
receiving, from the insured party, a request for renewal of the claims paid insurance policy; and
granting the request for renewal subject to the determining of the claims paid insurance premium.

5. The method of claim 1, further comprising:
performing a risk review of the insured party;
canceling the claims paid insurance policy of the insured party responsive to the risk review; and
providing tail coverage to the insured party for an open claim.

6. The method of claim 1, further comprising:
defending the claim against the insured party.

7. The method of claim 1, wherein the insured party is indemnified for a loss due to at least one of professional liability, medical professional liability, property liability, and casualty liability.
